(19) United States
(12) Patent Application Publication
(10) Pub. No.: US 2006/0118384 A1
(43) Pub. Date: Jun. 8, 2006

(54) Clamping mechanism for pallet changer

(75) Inventors: Akira Funakoshi, Yamanashi (JP); Akihiko Fujimoto, Yamanashi (JP)

Correspondence Address: STAAS & HALSEY LLP, SUITE 700, 1201 NEW YORK AVENUE, N.W., WASHINGTON, DC, 20005, US

(73) Assignee: FANUC LTD, Yamanashi (JP)

(21) Appl. No.: 11/261,774

(22) Filed: Oct. 31, 2005

(30) Foreign Application Priority Data
Oct. 29, 2004 (JP) 2004-316386

(51) Int. Cl. B23Q 7/00

(52) U.S. Cl. 198/345.3

(57) ABSTRACT

In a pallet changer that changes pallets for mounting workpieces on a machine tool work table, a pallet changer clamping mechanism that clamps and unclamps a workpiece-mounting pallet to and from the work table, the pallet changer clamping mechanism comprising a workpiece-mounting pallet whose direction of delivery to and removal from the work table is the same as its direction of movement for clamping and unclamping. The workpiece-mounting pallet moves on a plane parallel to the work table when clamped to and unclamped from the work table.

### BACKGROUND OF THE INVENTION

1. Field of the Invention

The present invention relates to a clamping mechanism for a pallet changer for changing pallets on which a workpiece is mounted in a machine tool.

2. Description of the Related Art

With automation of machine tools, in the mounting a workpiece on a work table and removing the workpiece after machining, a pallet changer is used that changes the workpiece on the work table using a pallet on which the workpiece is mounted.

FIG. 11 is a diagram illustrating one example of the configuration of a conventional pallet changer. A pallet changer 101 is attached to a machine tool 100, with a plurality of pallets 102 rotatably supported on an elevator 104. In such a pallet changer 101, when changing the pallets 102, after the workpiece 103 is placed on the pallet 102 and the elevator 104 lifts the pallet 102 upward (in the direction indicated by arrow 121 in the diagram), the elevator 104 then rotates the pallet 102 (in the direction indicated by arrow 122) so as to move the workpiece 103 to a machining position of the machine tool 100. As a pallet changer of this type, those taught by JP 61-131844A and JP 5-85307B, for example, are known.

As described above, the conventional rotary type pallet changer lifts the pallet up when changing pallets and then lowers the pallet into place after rotation, and thus requires an elevator to raise and lower the workpiece-mounting pallet. As a result, the pallet changer requires both the vertical space in which to be able to raise and lower the pallet and the horizontal space in which to be able to rotate the pallet, thus necessitating a large area in which to change pallets.

In addition, the conventional rotary type pallet changer requires drive mechanisms to move the in two different directions of motion, vertically and rotationally, and thus requires a large number of components, which in turn increases the cost of the pallet changer.

### SUMMARY OF THE INVENTION

The present invention provides a clamping mechanism for a pallet changer that reduces a space needed to change pallets, and does so using a simple apparatus that reduces the amount of motion needed to change pallets.

A clamping mechanism of the present invention clamps/unclamps a workpiece-mounting pallet on a work table of a machine tool in a pallet changer for changing workpiece-mounting pallets.

According to one aspect of the present invention, the clamping mechanism comprises: supporting means for supporting the workpiece-mounting pallet movable in a direction of conveying the workpiece-mounting pallet to and from the work table; and clamping means for clamping/unclamping the workpiece-mounting pallet in the direction of conveying the workpiece-mounting pallet supported by the supporting means, wherein the workpiece-mounting pallet is moved on a plane parallel to the work table and clamped/unclamped on the work table.

With the above arrangement, the changing of the workpiece-mounting pallet can be accomplished simply by moving the pallet solely in a straight line, thus enabling the space required for changing the pallet to be reduced. Furthermore, such movement in the direction of a straight line is the same as the movement of the workpiece-mounting pallet in the direction of delivery to and removal from the work table, and since the pallet is moved in the same plane as the work table of the machine tool, the present invention does not require space other than that needed for the delivery and removal of the workpiece-mounting pallet to and from the machine tool work table, thus enabling the space required for changing of the pallet to be reduced to a minimum.

The workpiece-mounting pallet may be unclamped by utilizing a drive force of a driving mechanism of the machine tool provided for axially moving the work table. A separate drive source is not required by utilizing the drive force of the driving mechanism which is provided in the machine tool as a drive source for an unclamping operation of the clamping mechanism, enabling the structure of the mechanism to be simplified.

According to another aspect of the present invention, the clamping mechanism comprises: a cylindrical case; a sleeve slidably supported in the cylindrical case; an eject bar arranged inside of the sleeve and movable with the sleeve; an elastic member generating an elastic force for urging the eject bar and the sleeve with respect to the cylindrical case in a direction of conveying the workpiece-mounting pallet to the work table; and balls arranged movable radially of the cylindrical case to be in contact with an inner peripheral portion of the sleeve, wherein the sleeve slides in the cylindrical case by the elastic force of the elastic member such that the balls are moved radially inward of the cylindrical case to retain a pull stud provided on the workpiece-mounting pallet to be unmovable in the direction of conveying the workpiece-mounting pallet to/from the work table, thereby the workpiece-mounting pallet is clamped on the work table. With this arrangement, the elastic member provides a clamping force for clamping the workpiece-mounting pallet on the work table, thus enabling the structure of the mechanism to be simplified.

The clamping mechanism may further comprise a drive mechanism for moving the eject bar with respect to the cylindrical case in a direction of conveying the workpiece-mounting pallet from the work table by utilizing movement of the work table, wherein the drive mechanism moves the eject bar to press the pull stud of the workpiece-mounting pallet in the direction of conveying the workpiece-mounting pallet from the work table against the urging force of the elastic member so that the workpiece-mounting pallet is unclamped.

The cylindrical case may have a female taper with an inner diameter thereof increasing toward outside at one end confronting the pull stud of the workpiece-mounting pallet so that a tapered cone having the pull stud at a distal end thereof is fitted into the female taper. With this configuration, a position detector for positioning of the pallet or a specific mechanism for fixing the pallet in place are rendered unnecessary.

Accordingly, the pallet changer clamping mechanism of the present invention, by using a configuration that clamps the pallet in the direction of delivery and removal in the interior of the machine tool and that uses the drive force provided by the machine tool to provide the necessary force to clamp and unclamp the pallet, reduces the amount of space needed to change a pallet to a compact space, and does so using a simple apparatus that reduces the motion needed to change pallets.

In addition, the pallet changer clamping mechanism of the present invention renders an elevator for raising and lowering the pallet as in the conventional pallet changer unnecessary.

The present invention can clamp a pallet without an elevator for raising and lowering the workpiece-mounting pallet, enabling the drive means structure to be compact and simple.

In addition, the clamp/unclamp mechanism uses the drive force of the axis movement provided in the machine tool itself, thereby eliminating the need for a dedicated drive source for clamping and unclamping and thus enabling the clamp structure to be implemented inexpensively.

### BRIEF DESCRIPTION OF THE DRAWINGS

FIG. 1 is a diagram illustrating a general configuration of a clamping mechanism for a pallet changer of the present invention;

FIG. 2 is a diagram illustrating a layout of the clamping mechanism of the present invention;

FIG. 3 is a cross-sectional view illustrating one configuration of the clamping mechanism of the present invention;

FIG. 4 is a flow chart illustrating a clamping action of the present invention;

FIG. 5 is a flow chart illustrating an unclamping action of the present invention;

FIG. 6 is a cross-sectional view illustrating the clamping action of the present invention;

FIG. 7 is a cross-sectional view illustrating the clamping action of the present invention;

FIG. 8 is a cross-sectional view illustrating the clamping action of the present invention;

FIG. 9 is a cross-sectional view illustrating the clamping action of the present invention;

FIG. 10 is a cross-sectional view illustrating the unclamping action of the present invention; and

FIG. 11 is a diagram illustrating one example of the configuration of a conventional pallet changer.

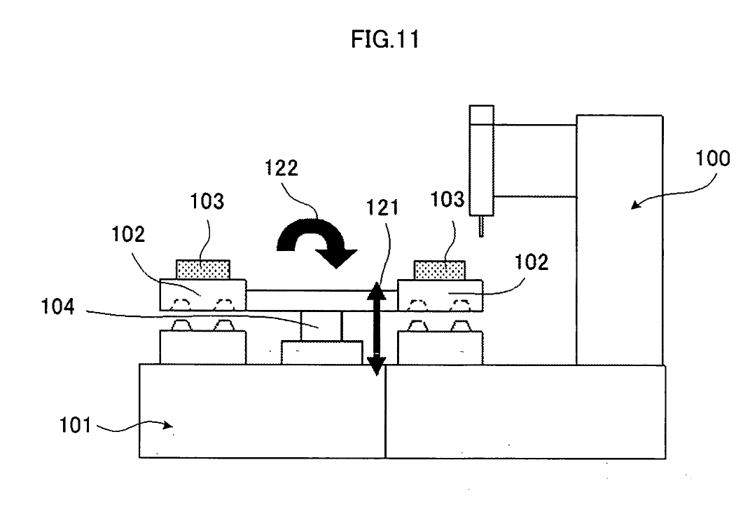

### DETAILED DESCRIPTION

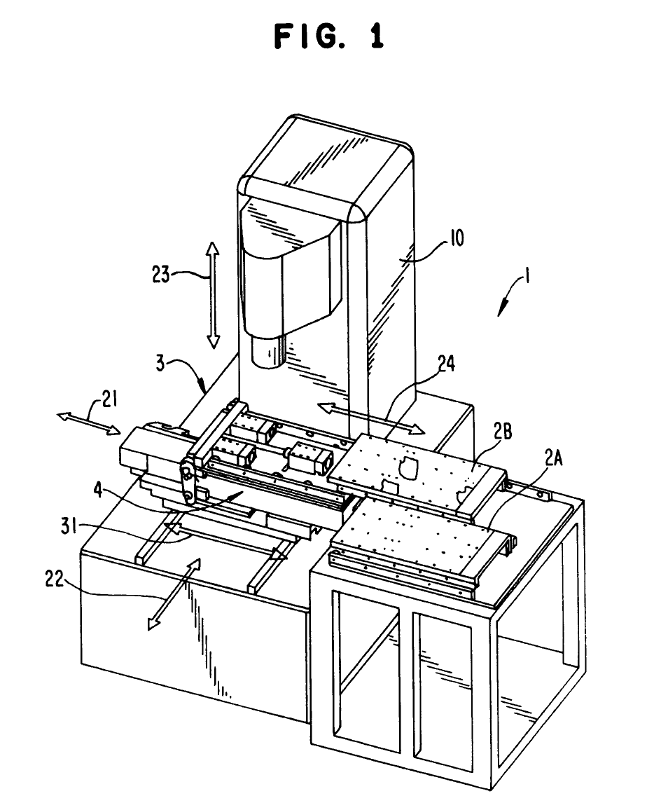

FIG. 1 is a diagram illustrating a general configuration of a clamping mechanism for a pallet changer which is applied to a machine tool according to the present invention.

In FIG. 1, a pallet changer 1 changes workpiece-mounting pallets 2A, 2B on a work table 4 of a machine tool 10. The workpieces that are the objects of machining, not shown, are mounted on a top surface of each of the workpiece-mounting pallets 2A, 2B at a location remote from the machining part in the machine tool 10. The workpieces mounted on the workpiece-mounting pallets 2A, 2B are delivered to the machining part of the machine tool 10 by the pallet changer 1 and then machined.

In addition, the finished workpiece is removed from the machining part to a location removed from the machining part inside the machine tool 10 or to the exterior of the machine tool 10 by the pallet changer 1.

By this changing of the workpiece-mounting pallets 2A, 2B by the pallet changer 1, workpieces are delivered to and removed from the machining part of the machine tool 10.

In FIG. 1, the machine tool 10 is equipped with drive mechanisms that drive the work table 4 in the direction of the X axis 21 and in the direction of the Y axis 22, and a drive mechanism that drives the machining head in the direction of the Z axis, with the workpiece placed on the work table 4 machined by being driven along each of these axes.

In the example shown in FIG. 1, the pallet changer 1 moves freely in the direction of the X axis 21, and the X axis 21 is the direction in which the workpiece-mounting pallet 2 is conveyed to be delivered to and removed from the work table 4.

It should be noted that the direction of delivery and removal 24 of the workpiece-mounting pallet 2 is not limited to the X axis as shown in the example shown in diagram, and may be the Y axis or some other axis. If the direction of delivery and removal is made to be each of the X axis, Y axis and Z axis, then drive mechanisms on the machine tool 10 for each of the directions X, Y and Z can be used for the drive mechanisms for delivering and removing the pallets. If the direction of delivery and removal of the pallets is some other direction besides the X, Y and Z axes, then the system may be configured so as to combine a plurality of axial drive mechanisms.

In order to move either the workpiece-mounting pallet 2A or the workpiece-mounting pallet 2B that has been delivered to and placed on the work table 4 of the machine tool 10, it is necessary to fix the workpiece-mounting pallet on the work table 4. The clamping mechanism 3 is a mechanism for fixing the workpiece-mounting pallet on the work table 4 and releasing it from the work table 4. The workpiece-mounting pallet is fixed in place on the work table 4 by the clamping action of the clamping mechanism 3, and the fixed pallet is released from the work table 4 by the unclamping action of the clamping mechanism 3.

The clamping mechanism 3 repeats the clamping action and the unclamping action and multiple workpieces are delivered to the machine tool machining position and machined, after which the finished workpieces are then removed.

The clamping operation of the clamping mechanism 3 can use the axial direction drive force of the machine tool 10 (in FIG. 1, the X-axis drive force 31). Therefore, in addition to the basic matter of the movement of the work table 4 as directed by the machine tool, the machine tool axial drive force is also used to deliver the workpiece-mounting pallets 2A, 2B as well as to clamp and unclamp the workpiece-mounting pallet 2A or 2B to and from the work table 4.

It should be noted that the action of delivering the workpiece-mounting pallet to the work table 4 can be carried out by a drive mechanism, not shown, or manually. The drive mechanism for carrying out this delivery action may be constituted separately from the machine tool 10, and moreover, it may utilize the drive force of each axis of the machine tool 10. In addition, the action of delivering the workpiece-mounting pallet to the work table 4 may be accomplished using a single axial drive force or a combination of multiple axial drive forces.

In FIG. 1, the workpiece-mounting pallets 2A, 2B are placed on a pallet stand 6 disposed adjacent to the machine tool 10, and a configuration is shown in which the workpiece-mounting pallet selected from between the workpiece-mounting pallets 2A, 2B (in FIG. 1, pallet 2B) is delivered along a horizontal movement support member guide for delivery. Alternatively, a drive mechanism that delivers the workpiece-mounting pallet that is selected to the machine tool 10 may be provided separately.

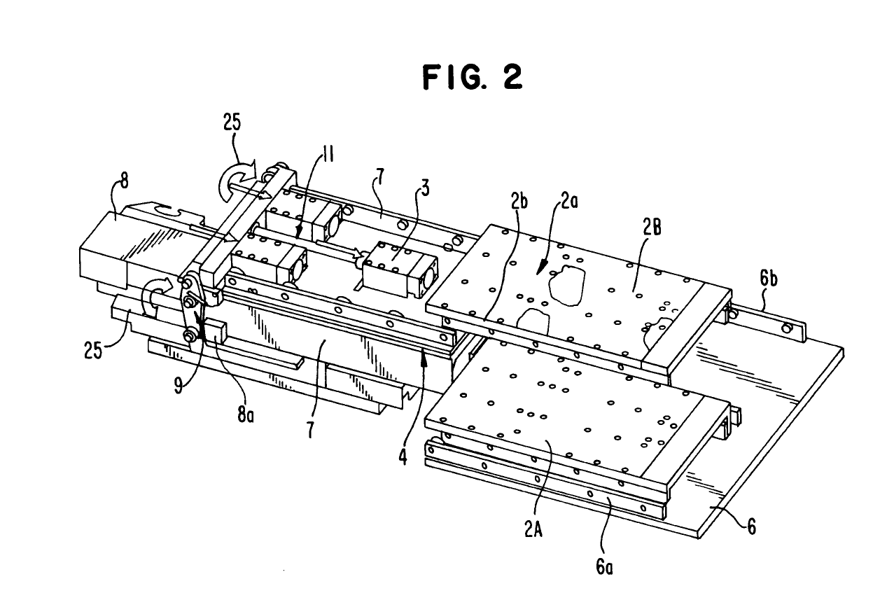

FIG. 2 illustrates the layout of the clamping mechanism of the present invention.

In FIG. 2, the clamping mechanism 3 and the workpiece-mounting pallets 2A, 2B are shown. The clamping mechanism 3 delivers and removes the workpiece-mounting pallets 2A, 2B to and from the work table 4 in the same direction in which it clamps and unclamps the workpiece-mounting pallets 2A, 2B to and from the work table 4, with the clamping and unclamping of the workpiece-mounting pallets 2A, 2B to and from the work table 4 performed on the same surface as that of the machine tool work table 4.

In the embodiment shown in FIG. 2, the clamping mechanism 3 and the horizontal movement support members 7 are mounted on the top surface of the work table 4. The work table 4 itself is moved in the axial direction (in the direction of the X axis) by an axial drive mechanism installed in the machine tool. It should be noted that although three of the clamping mechanisms 3 are shown in FIG. 2, any number of clamping mechanisms may be mounted.

The horizontal movement support members 7 provided on the sides of the work table 4 engage horizontal movement support members 6a provided on the pallet stand 6 so as to slidably support horizontal movement of the workpiece-mounting pallets 2A, 2B.

A saddle 8 is a member that supports the work table 4. The saddle 8 moves in the direction of the Y axis in the machine tool, by which it can move the work table 4 in the Y axis direction. Dogs 8a (only one of which is shown in FIG. 2) are mounted on both sides of the saddle 8 and rotating levers 9 are mounted on both sides of the work table 4, in such a way that one end of the rotating levers 9 is capable of contacting the dogs 8a.

When the work table 4 moves along the X axis (to the right in the diagram), one end of the rotating levers 9 contacts the dogs 8a. This contact causes the rotating levers 9 to rotate about their axes of rotation in the direction indicated by arrow 25 in the diagram. With this rotation, the other edge of the rotating levers 9 causes a rod 11 to move in the X axis direction (to the right in the diagram). This movement cause the rod 11 to act on an eject bar inside the clamping mechanisms 3, such that the drive force of the work table 4 is converted into a force that unclamps the clamped workpiece-mounting pallet.

A tapered member 2a, on top of which one or more workpieces are mounted and which is provided on the bottom thereof with pull studs (not shown in FIG. 2) for clamping to the clamping mechanism 3, are mounted on the workpiece-mounting pallets 2A, 2B.

It should be noted that, in FIG. 2, the tapered member 2a is equipped with three pull studs, corresponding to each of the three clamping mechanisms 3 provided on the work table 4, and can be positioned when clamping depending on the number and the location of the tapered portions 2a and clamping mechanisms 3.

The workpiece-mounting pallets 2A, 2B are supported by the horizontal movement support members 7, and move horizontally between the work table 4 and the pallet stand 6 in the same plane. The workpiece-mounting pallets 2A, 2B are delivered to the work table 4, the pull stud-equipped tapered portions 2a are aligned with the clamping mechanisms 3 and then clamped by the clamping mechanisms 3. This clamping action fixes the workpiece on the work table 4 so that the workpiece can be machined by the machine tool.

After machining is completed, the clamping mechanisms 3 are unclamped and the workpiece-mounting pallet is released and removed to the pallet stand 6 while being supported by the horizontal movement support members 7.

It should be noted that the horizontal movement support members 7 may, for example, be configured as a combination of guide rails and rollers, or may be some other configuration.

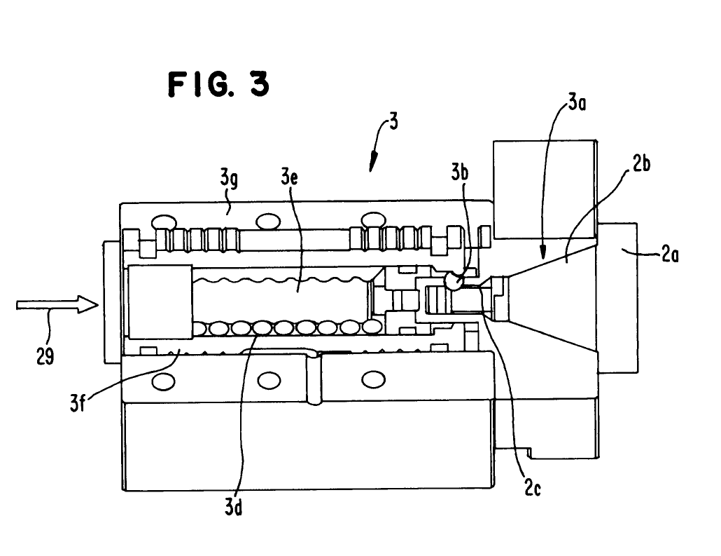

Next, a description is given of a configuration of the clamping mechanism 3, using the cross-sectional view shown in FIG. 3. The clamping mechanism 3 is comprised of a cylindrical case 3g, a sleeve 3f slidably supported with respect to the cylindrical case 3g, an eject bar 3e provided on the inside of the sleeve 3f and coupled to the sleeve 3, a spring member 3d that urges the eject bar 3e and the sleeve 3f in the direction of delivery of the workpiece-mounting pallet 2, and balls 3b supported so as to be movable toward the central axis of the clamping mechanism inside the sleeve 3f.

The spring member 3d is a compression spring, and the elastic force of the spring member 3d as it tries to return to its original shape urges the sleeve 3f in the direction of conveying the workpiece-mounting pallet 2 to be delivered to the work table 4 (to the left in the figure). The movement of the sleeve 3f as urged by the spring member 3d moves the balls 3b in the direction of the central axis of the cylindrical case 3g so as to retain the pull studs 2c of the workpiece-mounting pallet 2 as well as apply a clamping force in the direction of delivery of the workpiece-mounting pallet to the pull stud 2c.

On an end disposed toward the workpiece-mounting pallet, the cylindrical case 3g of the clamping mechanism 3 is provided with a female taper 3a whose interior diameter widens toward the outside from a position of insertion of the pull stud 2c. By contrast, the pull stud-equipped tapered member 2a is provided with a tapered cone 2b whose outer diameter narrows toward the tip of the pull stud 2c. The inclined surface of the female taper 3a and the inclined surface of the tapered cone 2b are formed to the same angle of inclination, so as to enable the tapered cone 2b to be inserted into the female taper 3a. By the engagement of the tapered cone 2b with the female taper 3a, the clamping mechanism 3 and the pallet 2 position the workpiece-mounting pallet.

The positioning of the workpiece-mounting pallet 2 aligns the tip of the pull stud 2c with a clamping position located at the position of the clamping mechanism 3 balls 3b.

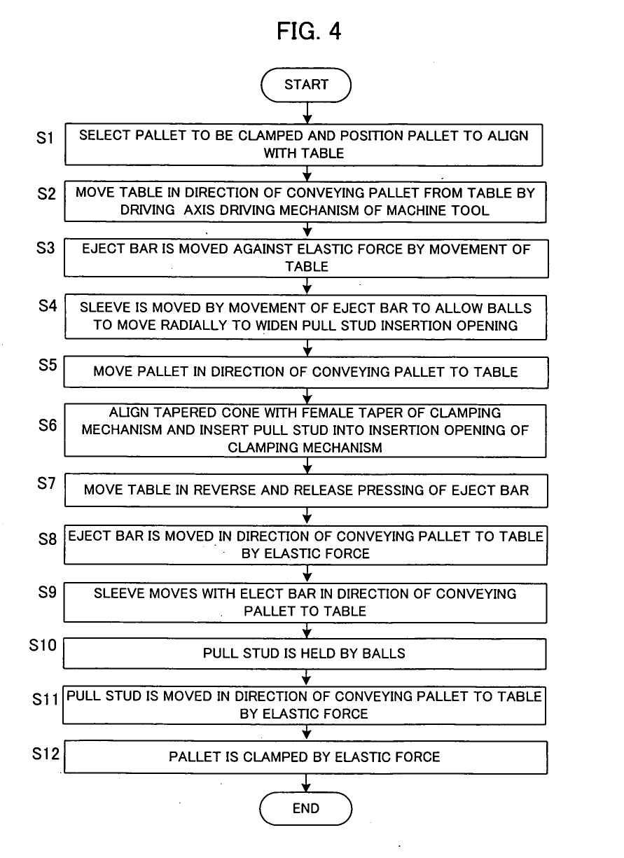

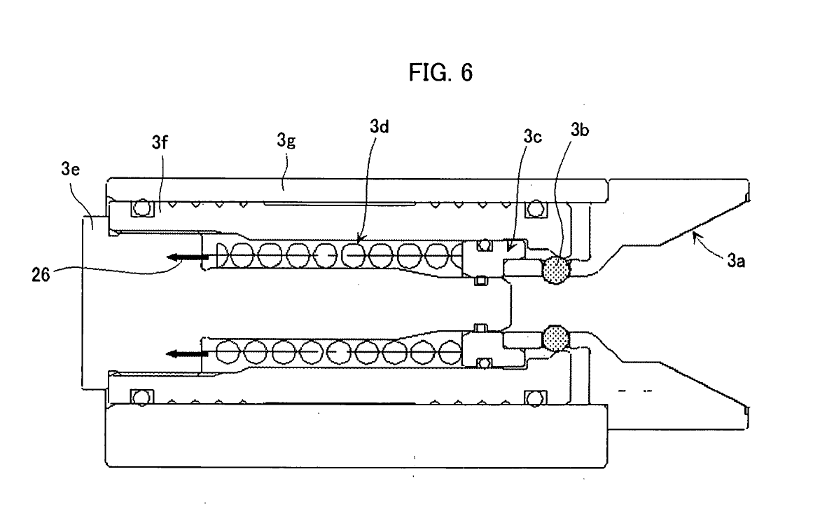

A description is now given of the clamping action and the unclamping action of the clamping mechanism 3 of the present invention, using the flow chart shown in FIG. 4 and the cross-sectional views presented in FIGS. 6-10.

First, a description is given of the clamping action, using the flow chart shown in FIG. 4 and FIGS. 6-9. It should be noted that, in an initial state, the workpiece-mounting pallet 2 is not mounted on the clamping mechanism 3.

From among a plurality of prepared workpiece-mounting pallets, a workpiece-mounting pallet 2 on which is mounted a workpiece to be machined by the machine tool is selected and positioned to be aligned with the machine tool work table. It should be noted that the alignment of the workpiece-mounting pallet 2 may be accomplished automatically by a separately supplied mechanism (Step S1).

FIG. 6 shows the initial state, in which a clamping action has not been carried out by the clamping mechanism. In this initial state, the restitutive force 26 of the spring member 3d urges the sleeve 3f and the eject bar e3 to move to the left in the diagram. It should be noted that one end of the spring member 3d is supported by the female taper 3a member and the cylindrical case 3g via a flange 3c and the balls 3b.

In order to clamp the pull stud 2c when clamping, the end of the sleeve 3f disposed toward the balls 3b side is provided with a projecting portion that projects toward the central axis of the clamping mechanism 3, which projects the balls 3b toward the central axis so as to grasp a portion of lesser diameter of an inserted pull stud 2c and clamp it.

In this initial state, since the balls 3b are projected toward the central axis by the projecting portion of the sleeve 3f, the pull stud 2c of an inserted workpiece-mounting pallet 2 are prevented from moving to a clamping position by the balls 3b.

Accordingly, the machine tool axis is driven so as to move the work table 4. As described using FIG. 2, when the work table 4 is moved, one end of the rotating levers 9 contacts the dogs 8a fixed on the saddle 8 and the rotating levers 9 rotate, pushing the rod 11 (Step S2).

The rod 11 pushes the eject bar 3e toward the workpiece-mounting pallet, against the elastic force of the spring member 3d (Step S3).

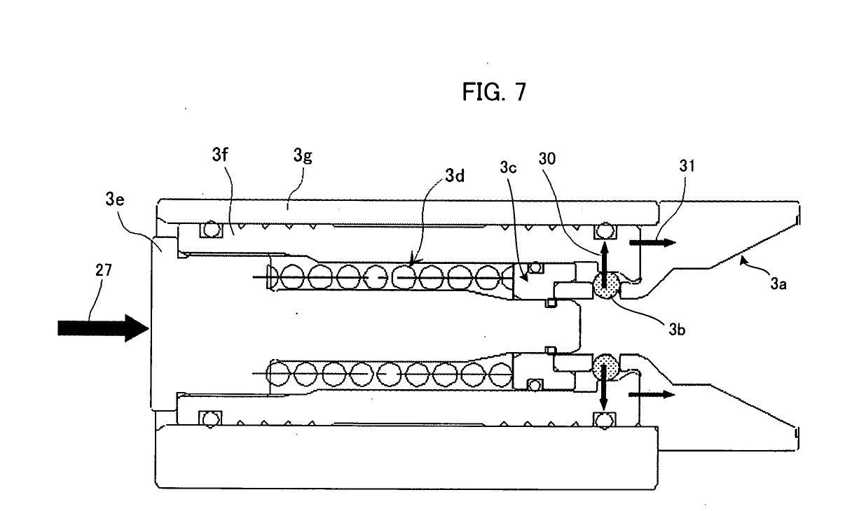

FIG. 7 shows a state in which the eject bar 3e has been moved. As the eject bar 3 moves (as indicated by arrow 27 in the diagram) the sleeve 3f also moves. The movement of the sleeve 3f (in the direction indicated by arrows 31) moves the projecting portion of the sleeve 3f away from the balls 3b, thus enabling the balls 3b to move in a direction 30 away from the central axis, widening the inner diameter of an opening into which the pull stud 2c is inserted and removed and thus enabling the pull stud 2c to be inserted to the clamping position. The foregoing action enables the workpiece-mounting pallet to be moved from an initial state to a state in which it can be clamped (Step S4).

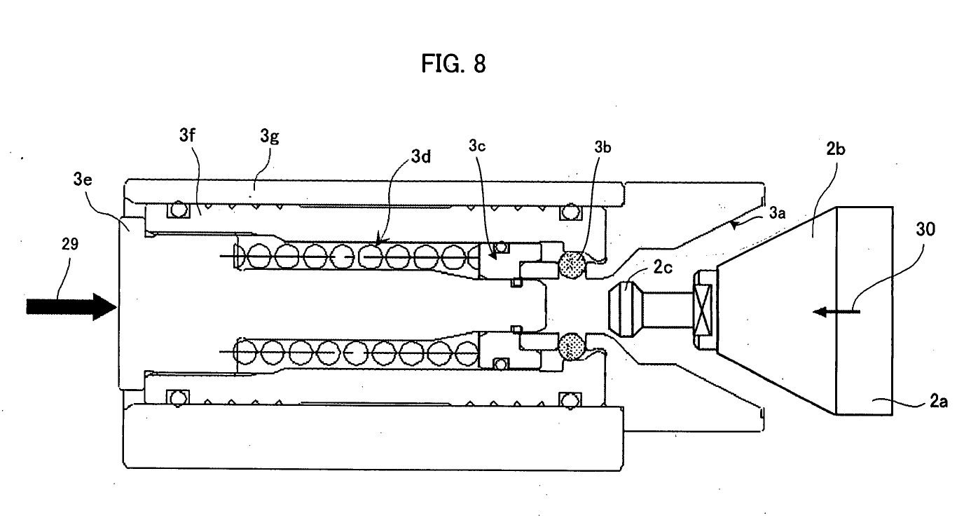

Next, the workpiece-mounting pallet 2 is moved in the direction of delivery. FIG. 8 shows the state of delivery of the workpiece-mounting pallet 2. In a state in which the eject bar 3e pushed by the driving force of the rod 11 caused by the movement of the work table 4 (the direction indicated by arrow 29 in the diagram), the workpiece-mounting pallet 2 is moved in the direction of delivery (to the left in the diagram) (Step S5).

In the delivery of the workpiece-mounting pallet 2, the engagement of the tapered cone 2b with the female taper 3a of the clamping mechanism 3 inserts the pull stud 2c into the opening in the clamping mechanism 3 into which the pull studs 2c are inserted and removed, thus aligning the pull stud 2c with a clamping position (Step S6).

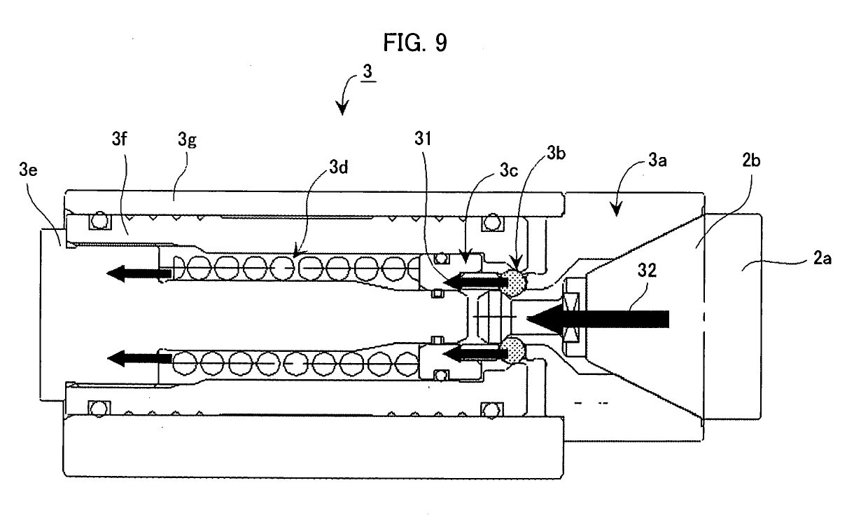

FIG. 9 illustrates a clamped state. After alignment is completed, when the work table 4 is moved in reverse and the pressing of the rotating levers 9 against the eject bar 3e through the rod 11 is released (Step S7). When the pressing of the rotating levers 9 on the eject bar 3e through the rod 11 is released, the eject bar 3e is moved in reverse by the elastic force 31 of the spring member 3d, that is, in the direction of delivery of the workpiece-mounting pallet 2 (Step S8). As the eject bar 3e moves in reverse, the sleeve 3f moves in the direction of delivery of the workpiece-mounting pallet 2 (Step S9).

The movement of the sleeve 3f in the direction of delivery of the workpiece-mounting pallet 2 causes the projecting portion of the sleeve 3f to contact the balls 3b, thus causing the balls 3b to move toward the central axis, where they enter into and engage the portion of lesser diameter of the pull studs 2c so as to retain the pull studs 2c (Step S10).

Furthermore, the pull studs 2c held in place by the elastic force 31 of the spring member 3d are moved in the direction of delivery (Step S11) and the workpiece-mounting pallet is clamped. Reference numeral 32 in the diagram shows a clamping force exerted against the taper cone 2b by the elastic force 31 of the spring member 3d (Step S12).

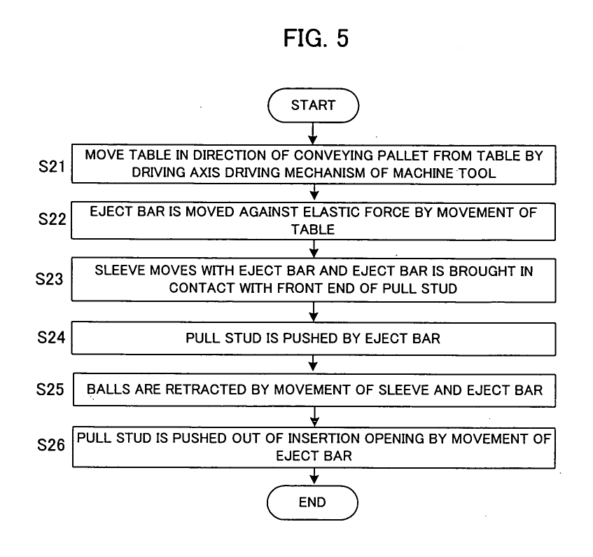

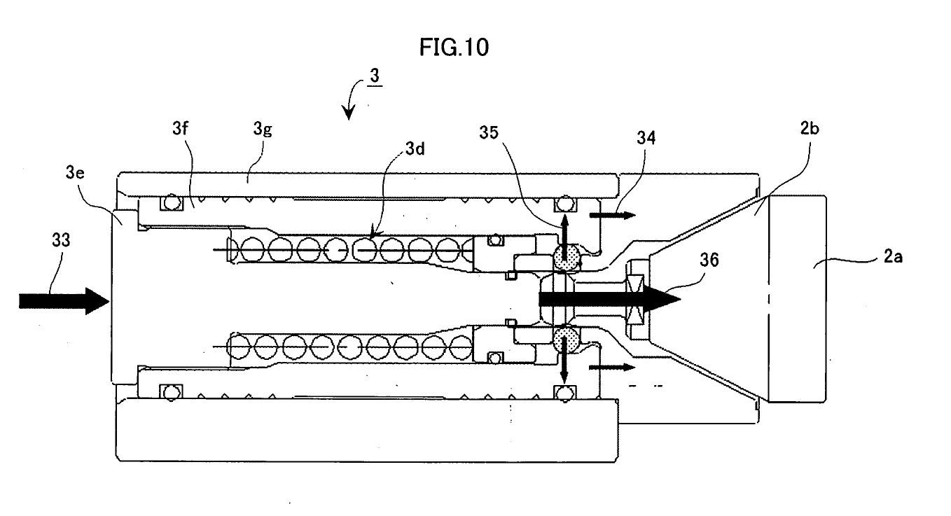

Next, a description is given of the unclamping action, using the flow chart shown in FIG. 5 and FIG. 10. Here, a description is given of an instance in which a workpiece-mounting pallet placed in a clamped state by the clamping action described above is unclamped.

The axis of the machine tool is driven, moving the work table 4. As illustrated by FIG. 2, when the work table 4 is moved, one end of the rotating levers 9 contacts the dogs 8a fixedly mounted on the saddle 8 and the rotating levers 9 rotate, pushing the rod 11 (Step S21).

The rod 11 moves the eject bar 3e in the direction of removal of the workpiece-mounting pallet, against the elastic force of the spring member (the direction indicated by arrow 33) (Step S22).

The sleeve 3f moves with the eject bar 3e and the eject bar 3e is brought in contact with the front end of the pull studs 2c Step S23). The eject bar 3e is further moved and to push the pull studs 2c in the direction of removal (Step S24).

At this time, by the movement of the sleeve 3f and the eject bar 3e in the direction of removal, the balls 3b are moved in a direction 35 away from the central axis to be retracted, thus widening the passageway through which the pull studs 2c pass upon removal, which had been narrowed by the balls 3b, and thereby allowing the pull studs 2c to be removed (Step S25).

The eject bar 3e is further moved to push the pull studs 2c out of the opening through which the pull studs are inserted and removed (indicated by arrow 36 in the diagram), unclamping the workpiece-mounting pallet (Step S26).

What is claimed is:

1. A clamping mechanism for clamping/unclamping a workpiece-mounting pallet on a work table of a machine tool in a pallet changer for changing workpiece-mounting pallets, comprising:
supporting means for supporting the workpiece-mounting pallet movable in a direction of conveying the workpiece-mounting pallet to and from the work table; and
clamping means for clamping/unclamping the workpiece-mounting pallet in the direction of conveying the workpiece-mounting pallet supported by said supporting means,
wherein the workpiece-mounting pallet is moved on a plane parallel to the work table and clamped/unclamped on the work table.

2. A clamping mechanism according to claim 1, wherein the workpiece-mounting pallet is unclamped by utilizing a drive force of a driving mechanism of the machine tool provided for axially moving the work table.

3. A clamping mechanism for clamping/unclamping a workpiece-mounting pallet on a work table of a machine tool in a pallet changer for changing workpiece-mounting pallets, comprising:
a cylindrical case;
a sleeve slidably supported in said cylindrical case;
an eject bar arranged inside of said sleeve and movable with said sleeve;
an elastic member generating an elastic force for urging said eject bar and said sleeve with respect to said cylindrical case in a direction of conveying the workpiece-mounting pallet to the work table; and
balls arranged movable radially of said cylindrical case to be in contact with an inner peripheral portion of said sleeve,
wherein said sleeve slides in said cylindrical case by the elastic force of said elastic member such that said balls are moved radially inward of said cylindrical case to retain a pull stud provided on the workpiece-mounting pallet to be unmovable in the direction of conveying the workpiece-mounting pallet to/from the work table, thereby the workpiece-mounting pallet is clamped on the work table.

4. A clamping mechanism according to claim 3, further comprising a drive mechanism for moving said eject bar with respect to said cylindrical case in a direction of conveying the workpiece-mounting pallet from the work table by utilizing movement of the work table, wherein said drive mechanism moves said eject bar to press the pull stud of the workpiece-mounting pallet in the direction of conveying the workpiece-mounting pallet from the work table against the urging force of said elastic member so that the workpiece-mounting pallet is unclamped.

5. A clamping mechanism according to claim 3, wherein said cylindrical case has a female taper with an inner diameter thereof increasing toward outside at one end confronting the pull stud of the workpiece-mounting pallet so that a tapered cone having the pull stud at a distal end thereof is fitted into said female taper.
